(19) United States
(12) Patent Application Publication
(10) Pub. No.: US 2010/0079898 A1
(43) Pub. Date: Apr. 1, 2010

(54) MAGNETIC STORAGE APPARATUS AND SERVO INFORMATION REPRODUCING METHOD

(75) Inventor: Atsushi Watanabe, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/506,613

(22) Filed: Jul. 21, 2009

(30) Foreign Application Priority Data
Sep. 26, 2008 (JP) 2008-249294

(51) Int. Cl. G11B 21/02

(52) U.S. Cl. 360/75; G9B/21.003

(57) ABSTRACT

A magnetic storage apparatus includes a recording medium having a first area in which servo information for controlling a magnetic head is stored, and a second area in which correction information for correcting the servo information is stored, an amplifying part configured to amplify a reproduced signal obtained by reproducing information recorded in the storage medium by the magnetic head, and a control part configured to define a gain of the amplifying part on the basis of an amplitude of a first reference signal obtained by reproducing a first waveform for amplitude measurement stored in the first area and cause the amplifying part to amplify a first reproduced signal obtained by reproducing the servo information and being configured to define the gain of the amplifying part on the basis of an amplitude of a second reference signal obtained by reproducing a second waveform for amplitude measurement stored in the second area and cause the amplifying part to amplify a second reproduced signal obtained by reproducing the correction information.

### CROSS-REFERENCE TO RELATED APPLICATION

This application is based upon and claims the benefit of priority of the prior Japanese Patent Application No. 2008-249294, filed on Sep. 26, 2008, the entire contents of which are incorporated herein by reference.

### FIELD

A certain aspect of the embodiments described herein is related to a magnetic storage apparatus and a servo information reproducing method.

### BACKGROUND

A magnetic disk drive, which is a typical example of the magnetic storage apparatus, is equipped with a magnetic disk having a recording layer, which may be made of a magnetic member and may be formed on a single side or both sides of the magnetic disk. Information may be written in or read from the recording layer by using a magnetic head. The magnetic disk drive is needed to precisely position the magnetic head at a target position on the magnetic disk. Thus, the magnetic disk has an area in which information used to identify the position of the magnetic head is stored. Such an area is called servo frame. FIG. 1 illustrates an exemplary arrangement of servo frames. A plurality of servo frames 3 radially extend from the inner side to the outer side of a magnetic disk 2 and are circumferentially arranged at equal intervals. There are several proposals to precisely read the information recorded in the servo frames because improvement in the precision of reading the servo information leads to improvement in the precision of positioning the magnetic head (see Japanese Laid-Open Patent Publication No. 8-180622).

As depicted in FIG. 1, each servo frame 3 has a preamble section 31, a servo mark (SM) section 32, a gray code section 33, a burst section 34, a post code section 40 and a gap section 35.

Information in each servo frame 3 other than the information stored in the post code section 40 is recorded on the magnetic disk 2 by a particular writer called servo track writer. A servo section 30 is defined as a section including the preamble section 31, the servo mark section 32, the gray code section 33 and the burst section 34. Information is written in the post code section 40 on the magnetic disk 2 by a magnetic disk drive having the magnetic disk 2 after a repeatable runout (frequently abbreviated as RRO) is measured. FIG. 2 illustrates a reproduced signal obtained by reading and reproducing information stored in the servo section 30 and a reproduced signal obtained by reading and reproducing information stored in the post code section 40. The repeatable runout is a fluctuation of the magnetic disk 2 due to its eccentricity, and takes place in a cycle of one rotation of the magnetic disk 2. The post code section 40 stores information for restraining the repeatable runout.

### SUMMARY

According to an aspect of the present invention, there is provided a magnetic storage apparatus including: a recording medium having a first area in which servo information for controlling a magnetic head is stored, and a second area in which correction information for correcting the servo information is stored; an amplifying part configured to amplify a reproduced signal obtained by reproducing information recorded in the storage medium by the magnetic head; and a control part configured to define a gain of the amplifying part on the basis of an amplitude of a first reference signal obtained by reproducing a first waveform for amplitude measurement stored in the first area and cause the amplifying part to amplify a first reproduced signal obtained by reproducing the servo information and being configured to define the gain of the amplifying part on the basis of an amplitude of a second reference signal obtained by reproducing a second waveform for amplitude measurement stored in the second area and cause the amplifying part to amplify a second reproduced signal obtained by reproducing the correction information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates locations of servo frames on a magnetic disk and an exemplary structure of the servo frames;

FIG. 2 is a waveform diagram of a signal reproduced from a serve section recorded in a magnetic disk by a servo track writer and a signal reproduced from a post code section recorded in the magnetic disk by a magnetic disk drive;

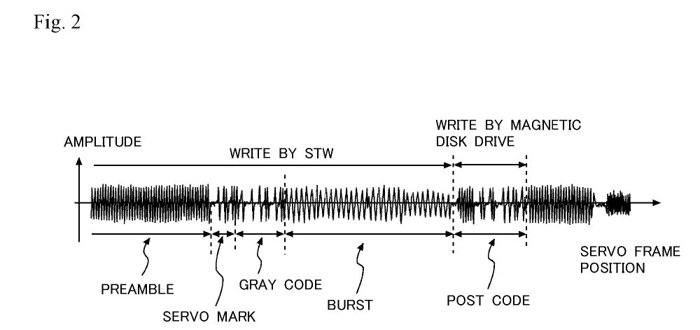

FIG. 3 is a block diagram of a magnetic disk drive;

FIG. 4 is a block diagram of a read channel unit illustrated in FIG. 3;

FIG. 5 is a flowchart of a process sequence by an AGC unit illustrated in FIG. 4;

FIG. 6 is a block diagram of a read channel unit employed in a second embodiment;

FIG. 7 illustrates a slice level for the servo section and that for the post code section;

FIG. 8 is a flowchart of a process sequence of an MPU illustrated in FIG. 6;

FIG. 9 illustrates an example of a management table;

FIG. 10 illustrates a variable r that indicates the position of a magnetic head over a magnetic disk in the radial direction;

FIG. 11 is a flowchart of creating the management table by the MPU; and

FIG. 12 illustrates orbits of tracks with respect to a magnetic head which is kept stationary by supplying a voice coil motor (actuator) with a constant current.

### DESCRIPTION OF EMBODIMENTS

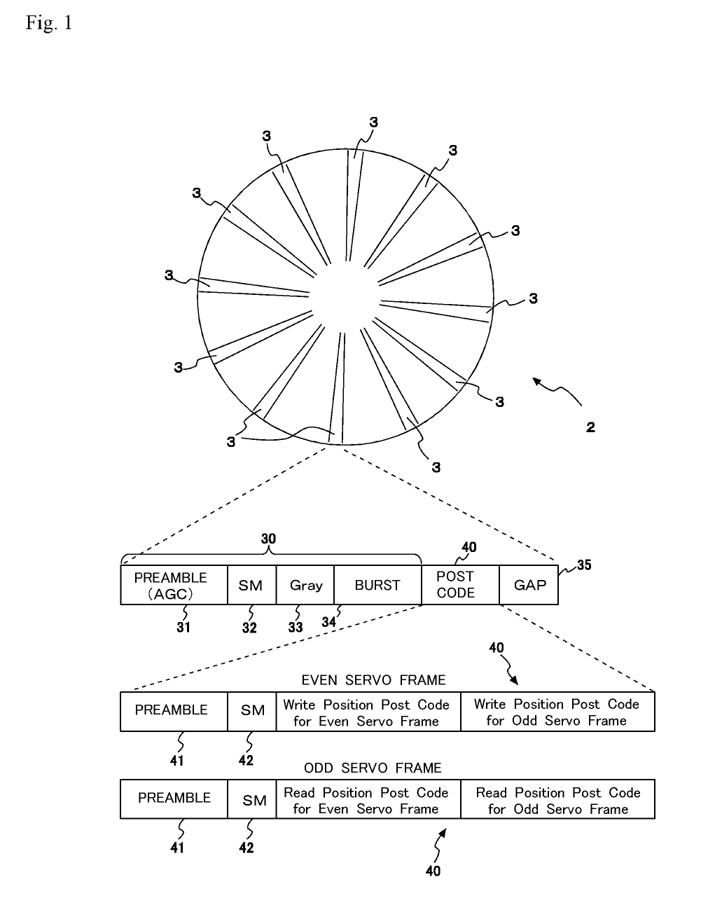

A further description will now be given of information recorded on the servo frame. The information for the servo section 30 in FIG. 1 is written in the servo frames 3 by the servo track writer, and the information for the post code section 40 is written by the magnetic disk drive in which the magnetic disks 2 are installed. This difference in writing may cause an error in signal level between the signal obtained by reading and reproducing the information recorded in the servo section 30 and the signal obtained by reading and reproducing the information recorded in the post code section 40. When the reproduced signals having the different signal levels are demodulated by an identical way, information obtained by the demodulation may be different from the original stored in the servo section 30 or the post code section 40. This is a read error on the bit base.

In the demodulation, a slice process for the reproduced signal is carried out as a pre-process. The slice process compares the amplitude of the reproduced signal with an amplitude defined as a slice level, and changes the amplitude that exceeds the slice level to the slice level. In a case where there is a great difference in the signal level between the reproduced signal of the servo section 30 and that of the post code section 40, if these reproduced signals are processed by an identical slice level, the demodulation process may malfunction to mistakenly determine an original value of “1” as “0”. This is a read error on the bit base.

A description will now be given of embodiments of the present invention with reference to the accompanying drawings.

### First Embodiment

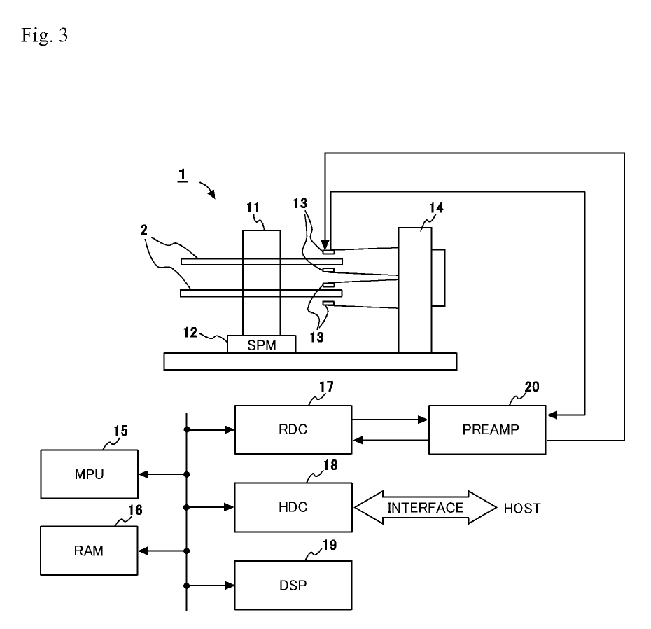

FIG. 3 is a block diagram of a magnetic disk drive 1 in accordance with a first embodiment. The magnetic disk drive 1 includes magnetic disks 2, a spindle motor (SPM) 12, magnetic heads 13 and an actuator 14.

The magnetic disks 2 are attached to a rotary shaft 11. The spindle motor 12 rotates the rotary shaft 11 so that the magnetic disk 2 can be rotated.

The magnetic heads 13 have read elements and write elements, and read and write data in and from the magnetic disks 2.

The actuator 14 includes a voice coil motor that rotates the rotary shaft 11 provided therein. The actuator 14 is equipped with the magnetic heads on ends thereof and is capable of moving the magnetic heads 13 in radial directions of the magnetic disks 2. In the exemplary structure illustrated in FIG. 3, the magnetic disk drive 1 has two magnetic disks 2, and four magnetic heads 13 are simultaneously driven by the single actuator 14. The magnetic disk drive 1 is not limited to the two magnetic disks 2 but may have a larger number of magnetic disks. The number of magnetic heads 13 may be selected taking the number of magnetic disks 2 into account.

The magnetic disk drive 1 has a micro processing unit (MPU) 15, a RAM 16, a read channel unit (RDC) 17, a hard disk controller (HDC) 18. a digital signal processor (DSP) 19 and a preamplifier (PreAmp) 20.

The MPU 15 controls the overall magnetic disk drive 1. For example, the MPU 15 analyzes commands, and monitors the condition of the magnetic disk drive 1. The MPU 15 controls the structural parts of the magnetic disk drive 1. The RAM 16 is used as a work area of the MPU 15. Information read from the servo frames 3 of the magnetic disk 2 is stored in the RAM 16.

The preamplifier 20 outputs a write signal for writing data in a corresponding one of magnetic disks 2 to a corresponding one of the magnetic heads 13. The preamplifier 20 amplifies a signal read and reproduced by the corresponding magnetic head 13 to the read channel unit 17. The read channel unit 17 shapes the waveform of the reproduced signal from the preamplifier 20. The shaping of the waveform may include amplifying and waveform-equalizing the reproduced signal. The output signal of the read channel unit 17 is applied to the DSP 19.

The hard disk controller 18 communicates with a host computer for the magnetic disk drive 1 so that commands and data are transferred between the magnetic disk drive 1 and the host computer. The hard disk controller 18 receive requests for operations of the magnetic disk drive 1 via an interface, which may be ATA (Advanced Technology Attachment) or SCSI (Small Computer System Interface).

The DSP 19 demodulates the information on the position of the magnetic head 13 by using the reproduced signal from the read channel unit 17, and detects the current position of the magnetic head 13. The DSP 19 detects a difference between the current position and the target position, and calculates a drive instruction value based on the difference, by which value the actuator 14 is driven. The DSP 19 executes a position control of the magnetic head 13 (seek control and tracking control) in accordance with the drive instruction value calculated by the above-described way.

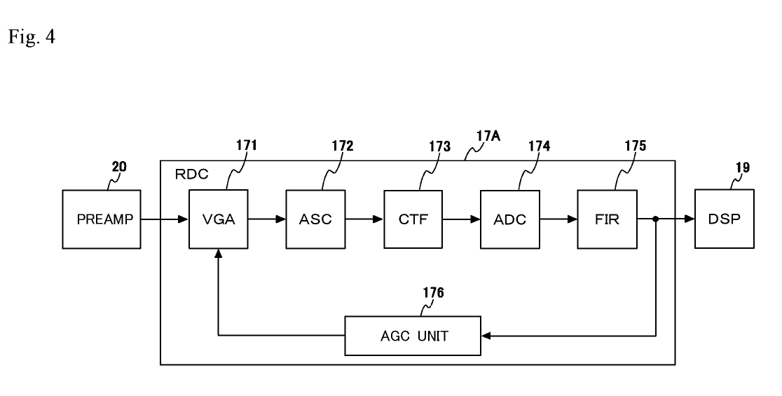

The details of the read channel unit 17 will now be described with reference to FIG. 4. The read channel unit 17 configured in accordance with the first embodiment is specifically given a reference numeral of 17A. The read channel unit 17A includes a variable gain amplifier (VGA) 171, an asymmetric collection unit (ASC) 172, a continuous time filter (CTF) 173, an analog-to-digital converter (ADC) 174, a finite impulse response (FIR) unit 175, and an automatic gain control (AGC) unit 176 (which corresponds to a controller in the first embodiment).

The variable gain amplifier 171 amplifies the amplitude of the reproduced signal from the preamplifier 20 with the gain set by the AGC unit 176. The asymmetric collection unit 172 corrects the asymmetry of the amplitude of the reproduced signal that is gain-adjusted by the variable gain amplifier 171. The continuous time filter 173 equalizes the waveform of the reproduced signal from the asymmetric collection unit 172 so as to coincide with a target waveform. The analog-to-digital converter 174 converts the reproduced signal from the continuous time filter 173 into a digital signal. The finite impulse response unit 175 equalizes the waveform of the digitized reproduced signal from the analog-to-digital converter 174 so as to coincide with a target waveform. The AGC unit 176 inputs the reproduced signal from the finite impulse response unit 175. The AGC unit 176 controls the gain of the variable gain amplifier 171 on the basis of the reproduced signal applied thereto so that the reproduced signal amplified by the variable gain amplifier 171 has a constant amplitude.

A further description will now be given, with reference to FIG. 1, of information written in the servo frames 3 on the magnetic disk 2. As has been described, each of the servo frames 3 includes the preamble section 31, the servo mark (SM) section 32, the gray code section 33, the burst section 34, the post code section 40 and the gap section 35. The servo section 30 includes the preamble section 31, the servo mark section 32, the gray code section 33 and the burst section 34. Information is written in the servo section 30 by the servo track writer before the magnetic disks 2 are mounted in the magnetic disk drive 1.

The preamble section 31 includes an AGC area in which a signal of a constant frequency used to stabilize the amplitude of the signal read from the magnetic disk 2 is stored. This signal in the AGC area has a waveform for amplitude measurement (first waveform). The servo mark section 32 stores a unique mark (servo mark) for identifying servo information recorded in the servo frames 3. The gray code section 33 stores an address (servo sector address) inherent in the corresponding servo frame 3 having the present gray code section 33, and a cylinder address (cylinder code) of a corresponding track. The burst section 34 stores burst data, which is a positional error signal for indicating, as an amplitude of the waveform, the waveform of a positional error in the cylinder designated by the cylinder address in the gray code section 33. The post code section 40 is arranged in the rear side of the servo frame 3, and stores, in the form of numeric values, information (correction data) for correcting a positional error that cannot be corrected by the servo information stored in the servo section 30 after the magnetic disk drive 1 is installed in an apparatus main body. The post code section 40 has a preamble section 41, which stores a signal of a constant frequency used to stabilize the amplitude of the signal reproduced from the post code section 40. This signal in the preamble section 41 has a waveform for measuring the amplitude (second waveform). The post code section 40 has a servo mark (SM) section 42 in which correction data is recorded. The content of the correction data for an even servo frame is different from that of the correction data for an odd servo frame. Each even servo frame 3 has correction data for correcting the write position, and each odd servo frame 3 has correction data for correcting the read position. The gap section 35 is a margin area used to prevent information in the servo frames 3 from being erased even when the revolution of the magnetic disk 2 deviates from the reference due to variation in the rotation of the magnetic disk 2 or eccentricity thereof to cause the start position in writing to be changed.

The present embodiment has a process for setting or determining the gain of the variable gain amplifier 171 that amplifies the signal reproduced from the servo section 30 by the magnetic head 13, and a process for setting or determining the gain of the variable gain amplifier 171 that amplifies the signal reproduced from the post code section 40 by the magnetic head 13.

The AGC unit 176 sets the gain of the variable gain amplifier 171 as follows. The AGC unit 176 obtains the magnitude of the amplitude of the signal reproduced from the preamble section 31 in the servo section 30, and stores the magnitude of the amplitude in an inner memory (not illustrated) provided in the AGC unit 176. The AGC unit 176 sets the gain of the variable gain amplifier 171 that amplifies the signal reproduced from the servo section 30 on the basis of the magnitude of the amplitude of the reproduced signal stored in the inner memory.

At a timing of reproducing information from the post code section 40, the AGC unit 176 obtains the magnitude of the amplitude of the signal reproduced from the preamble section 41 in the post code section 40, and stores the magnitude of the amplitude in the inner memory. The AGC unit 176 divides the magnitude of the amplitude of the signal reproduced from the preamble section 41 in the post code section 40 by the magnitude of the amplitude of the signal reproduced from the preamble section 31 in the servo section 30. This division results in an amplitude ratio K (RRO) of the post code section 40 to the servo section 30.

The AGC unit 176 compares the amplitude ratio K(RRO) with a predetermined upper threshold value and a predetermined lower threshold value. When the amplitude ratio K(RRO) is greater than the lower threshold value and smaller than the upper threshold value, the AGC unit 176 sets the gain for amplifying the signal reproduced from the servo section 30 in the variable gain amplifier 171. The variable gain amplifier 171 amplifies the signal reproduced from the post code section 40 with the same gain as that used to amplify the signal reproduced from the servo section 30. That is, the AGC unit 176 understands that there is no need to change the gain of the variable gain amplifier 171 since there is only a small difference in magnitude between the amplitude of the signal reproduced from the servo section 30 and the amplitude of the signal reproduced from the post code section 40.

When the amplitude ratio K(RRO) is equal to or smaller than the lower threshold value, or is equal to or greater than the upper threshold value, the AGC unit 176 newly sets the gain of the variable gain amplifier 171 that amplifies the signal reproduced from the post code section 40. The AGC unit 176 multiplies the gain of the variable gain amplifier 171 set for amplifying the signal reproduced from the servo section 30 by the reciprocal of the amplitude ratio K(RRO). The AGC unit 176 sets the gain of the variable gain amplifier 171 that amplifies the signal reproduced from the post code section 40 to the multiplied value. That is, the gain of the variable gain amplifier 171 that amplifies the signal reproduced from the post code section 40 is corrected on the basis of the ratio between the magnitude of the amplitude of the signal reproduced from the preamble section 31 in the servo section 30 and the magnitude of the amplitude of the signal reproduced from the preamble section 41 in the post code section 40. It is thus possible to set the gain of the variable gain amplifier 171 that amplifies the signal reproduced from the post code section 40 to an optimal value. The AGC unit 176 determines whether the gain of the variable gain amplifier 171 should be corrected by comparing the ratio between the magnitude of the amplitude of the signal reproduced from the servo section 30 and the magnitude of the amplitude of the signal reproduced from the post code section 40 with the lower and upper threshold values. It is thus possible to correct the gain of the variable gain amplifier 171 only when the gain should be corrected.

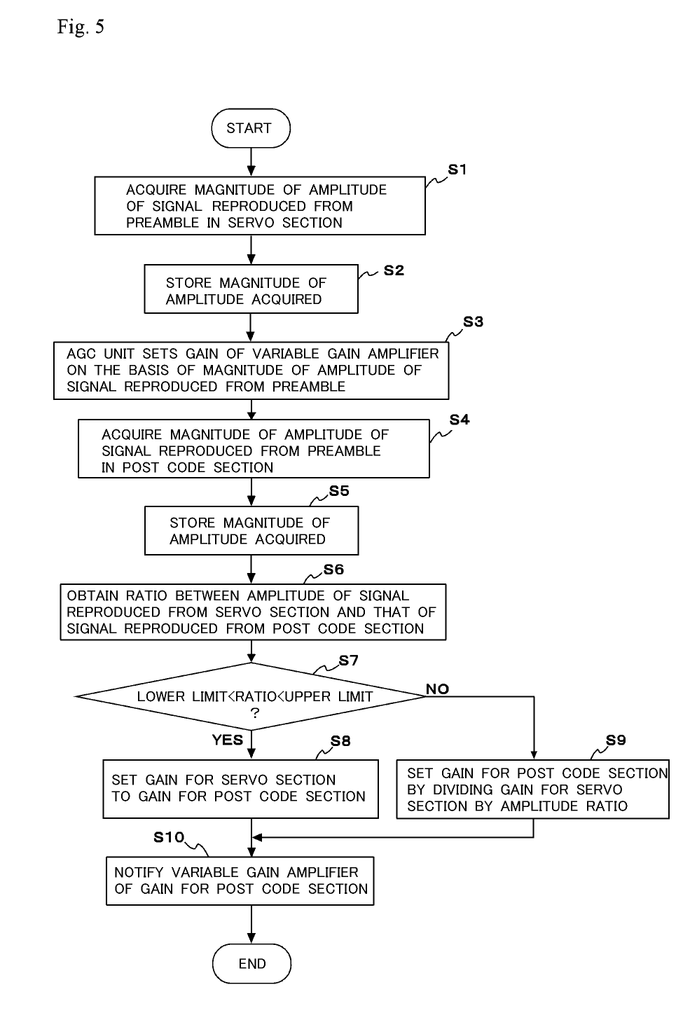

A description will now be given of a control sequence of the AGC unit 176 with reference to a flowchart of FIG. 5.

The AGC unit 176 acquires the signal reproduced from the preamble section 31 in the servo section 30 output via the finite impulse response unit 175 at step S1, and stores the magnitude of the amplitude of the reproduced signal (first reference signal) in the inner memory at step S2. At step S3, the AGC unit 176 sets the gain of the variable gain amplifier 171 that amplifies the signal reproduced from the servo section 30 by using the signal reproduced from the preamble section 31 in the servo section 30. The variable gain amplifier 171 amplifies the signal reproduced from the servo section 30 with the gain set by the AGC unit 176.

The AGC unit 176 acquires the signal reproduced from the preamble section 41 in the post code section 40 output via the finite impulse response unit 175 at step S4, and stores the magnitude of the amplitude of the reproduced signal (second reference signal) in the inner memory at step S5. The AGC unit 176 sets the gain of the variable gain amplifier 171 that amplifies the signal reproduced from the post code section 40. That is, at step S6, the AGC unit 176 divides the magnitude of the amplitude of the signal reproduced from the preamble section 41 in the post code section 40 stored in the inner memory by the magnitude of the amplitude of the signal reproduced from the preamble section 31 in the servo section 30 to thus obtain the amplitude ratio K(RRO). At step S7, the AGC unit 176 compares the amplitude ratio K(RRO) thus obtained with the lower threshold value and the upper threshold value. When the answer of step S7 is YES, that is, when the amplitude ratio K(RRO) is greater than the lower threshold value and is smaller than the upper threshold value, the AGC unit 176 sets the gain with which the signal reproduced from the servo section 30 is amplified in the variable gain amplifier 171 at step S8. That is, at step S8, the variable gain amplifier 171 amplifies the signal reproduced from the post code section 40 with the gain that is set in the variable gain amplifier 171 on the basis of the magnitude of the amplitude of the signal reproduced from the preamble section 31 in the servo section 30 without changing the above gain.

In contrast, when the answer of step S7 is NO, that is, when the amplitude ratio is equal to or smaller than the lower threshold value or is equal to or greater than the upper threshold value, the AGC unit 176 divides the gain set for amplifying the signal reproduced from the servo section 30 by the amplitude ratio K(RRO) at step S9. The AGC unit 176 sets the gain obtained at step S9 in the variable gain amplifier 171 that amplifies the signal reproduced from the post code section 40. At step S10, the AGC unit 176 notifies the variable gain amplifier 171 of the gain thus defined. The variable gain amplifier 171 amplifies the signal reproduced from the post code section 40 with the gain that is set by the AGC unit 176.

Thus, the first embodiment is capable of amplifying the signal reproduced from the post code section 40 in each servo frame 3 with an optimized gain. It is thus possible to maintain the amplitude of the signals reproduced from the servo frames at a constant level and to reduce the possibility that bit-base error may take place.

### Second Embodiment

A second embodiment will now be described with the accompanying drawings, in which parts that are the same as those of the first embodiment are given the same reference numerals.

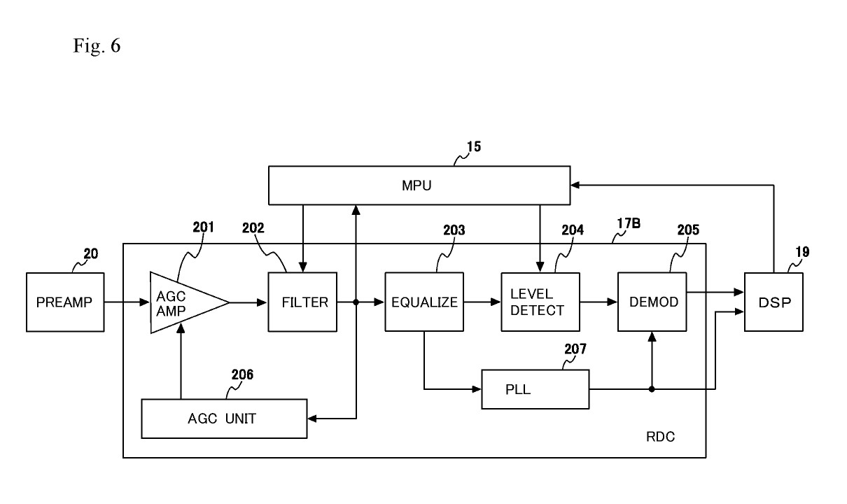

FIG. 6 is a block diagram of a read channel unit 17B employed in the second embodiment. The read channel unit 17B includes an automatic gain control (AGC) amplifier 201, a filter 202, an equalizer 203, a level detection circuit 204, a demodulator 205, an AGC unit 206, and a phase-locked loop (PLL) circuit 207.

The reproduced signal from the preamplifier 20 is supplied to the AGC amplifier 201 of the read channel unit 17B. The AGC amplifier 201 has the gain that is varied by an AGC control signal from the AGC unit 206 so that the amplitude of the reproduced signal from the magnetic head 13 is maintained at a constant level. The reproduced signal amplified by the AGC amplifier 201 is applied to the filter 202.

The filter 202 functions to remove unwanted components included in the reproduced signal from the AGC amplifier 201. The filter 202 is supplied with a cutoff frequency control signal from the MPU 15. The cutoff signal of the filter 202 is controlled by the cutoff frequency control signal supplied from the MPU 15, so that the pass band can be defined. The reproduced signal from which the unwanted components have been removed is supplied to the equalizer 203, the AGC unit 206 and the MPU 15.

The AGC unit 206 detects the amplitude of the reproduced signal from the filter 202, and generates the AGC control signal that reduces the gain of the AGC amplifier 201 when the amplitude exceeds a predetermined amplitude. When the amplitude of the reproduced signal is smaller than the predetermined amplitude, the AGC unit 206 generates the AGC control signal that increases the gain of the AGC amplifier 201. The AGC control signal thus generated is supplied to the AGC amplifier 201 by the AGC unit 206. The gain of the AGC amplifier 201 is changed by the AGC control signal, so that the reproduced signal from the corresponding magnetic head 13 can be maintained so as to have the constant amplitude.

The equalizer 203 removes a distortion of the reproduced signal from the filter 202. The reproduced signal from which the distortion has been removed is supplied to the level detection circuit 204 and the PLL circuit 207. The level detection circuit 204 slices the reproduced signal at a predetermined slice level so that the reproduced signal can be shaped in a pulse-like waveform. That is, the amplitude of the reproduced signal is compared with the slice level or amplitude, and the amplitude over the slice level is corrected to the amplitude of the slice level. The level detection circuit 204 is supplied with a slice level control signal from the MPU 15, and the slice level can be changed by the slice level control signal.

The PLL circuit 207 generates a clock synchronized with the reproduced signal from the equalizer 203. Hereinafter, the clock is referred to as synchronous clock. The synchronous clock generated by the PLL circuit 207 is supplied to the demodulator 205, and is supplied to the DSP 19 together with data demodulated by the demodulator 205. The reproduced signal that has been shaped by the level detection circuit 204 is applied to the demodulator 205, which demodulates the reproduced signal to make a decision as to whether the signal is “1” or “0” by processing the reproduced signal from the level detection circuit 204 in synchronism with the synchronous clock from the PLL circuit 207.

The second embodiment has a process for setting the slice level for shaping the waveform of the signal reproduced from the servo section 30, and a process for setting the slice level for shaping the waveform of the signal reproduced from the post code section 40.

The MPU 15 receives the reproduced signal that has been filtered by the filter 202, and detects the magnitude of the amplitude of the reproduced signal. The MPU 15 detects the magnitude of the amplitude of the signal reproduced from the preamble section 31 in the servo section 30, and the magnitude of the amplitude of the signal reproduced from the preamble section 41 in the post code section 40. The MPU 15 divides the magnitude of the amplitude of the signal reproduced from the preamble section 41 by the magnitude of the amplitude of the signal reproduced from the preamble section 31 to thus obtain the amplitude ratio K(RRO) between the servo section 30 and the post code section 40.

The MPU 15 compares the amplitude ratio K(RO) thus obtained with the predetermined upper and lower threshold values. When it is determined that the amplitude ratio K (RRO) is greater than the lower threshold value and is smaller than the upper threshold value, the MPU 15 sets the slice level defined for the signal reproduced from the servo section 30 in the level detection circuit 204. The level detection circuit 204 slices the amplitude of the signal reproduced from the post code section 40 at the slice level that is set for the signal reproduced from the servo section 30.

In contrast, when the amplitude ratio K(RRO) is equal to or smaller than the lower threshold value or is equal to or greater than the upper threshold value, the MPU 15 determines a new slice level for processing the reproduced signal from the post code section 40. The MPU 15 multiplies the amplitude radio K(RRO) by the slice level for processing the reproduced signal from the servo section 30, and determines a multiplied value to be the slice level for slicing the signal reproduced from the post code section 40. That is, the slice level for shaping the waveform of the signal reproduced from the post code section 40 is corrected on the basis of the ratio between the magnitude of the amplitude of the signal reproduced from the servo section and the magnitude of the amplitude of the signal reproduced from the post code section 40. It is thus possible to set the slice level for the signal reproduced from the post code section 40 to an optimized value and to demodulate the signal in the post code section 40 appropriately. The AGC unit 176 compares the ratio between the magnitude of the amplitude of the signal reproduced from the servo section 30 and the magnitude of the amplitude of the signal reproduced from the post code section 40 with the lower and upper threshold values and thus determines whether the slice level used in the level detection circuit 204 should be corrected. It is thus possible to correct the slice level of the level detection circuit 204 only when the correction should be made.

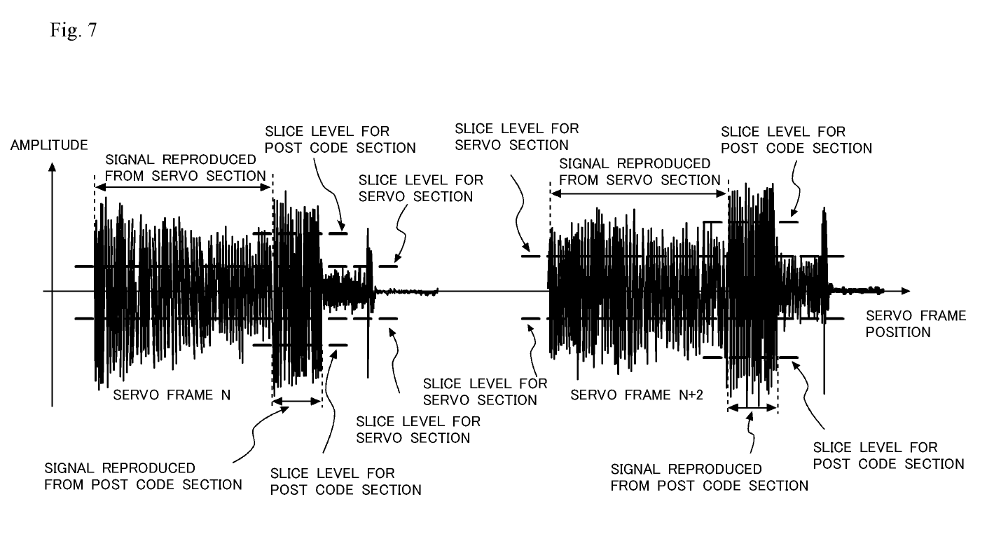

FIG. 7 illustrates the slice level for slicing the signal reproduced from the servo section 30 and that for slicing the signal reproduced from the post code section 40. FIG. 7 depicts the signal obtained by reproducing information stored in the Nth servo frame 3 (N is a natural number) and that obtained by reproducing information stored in the (N+2)th servo frame 3. In the example illustrated in FIG. 7, the amplitude of the reproduced signal from the servo section 30 is greatly different from that of the reproduced signal from the post code section 40. By separately setting the slice level for the signal reproduced from the servo section and the slice level for the signal reproduced from the post code section 40, it is possible to demodulate information in the post code section 40 appropriately.

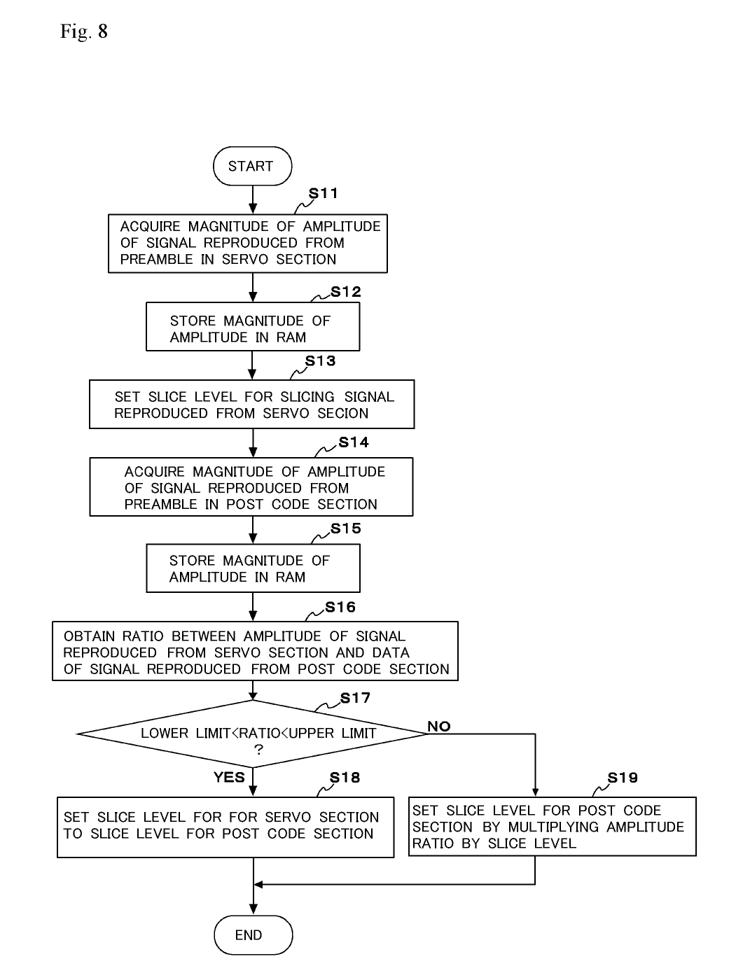

The process sequence of the MPU 15 will now be described with reference to a flowchart of FIG. 8. The MPU 15 acquires the signal reproduced from the preamble section 31 in the servo section 30 from the filter 202 at step S11, and writes the amplitude of the reproduced signal in the RAM 16 at step S12. The MPU 15 sets the slice level for slicing the amplitude of the reproduced signal from the servo section 30 at step S13. The level detection circuit 204 of the read channel unit 17B slices the reproduced signal from the servo section 30 at the slice level defined by the MPU 15. That is, the level detection circuit 204 corrects the amplitude of the reproduced signal that exceeds the slice level defined by the MPU 15 to the amplitude defined as the slice level.

The MPU 15 acquires the signal reproduced from the preamble section 41 in the post code section 40 from the filter 202 at step S14, and stores the amplitude of the reproduced signal in the RAM 16 at step S15. The MPU 15 sets the slice level for the post code section 40. That is, the MPU 15 divides the magnitude of the amplitude of the reproduced signal from the preamble section 41 by the magnitude of the amplitude of the reproduced signal from the preamble section 31 to thus obtain the amplitude ratio K(RRO) at step S16. The MPU 15 compares the amplitude ratio K(RRO) thus obtained with the predetermined upper and lower threshold values at step S17. When the amplitude ratio K(RRO) is greater than the lower threshold value and is smaller than the upper threshold value (YES at step S17), the MPU 15 determines the slice level obtained from the signal reproduced from the servo section 30 to be the slice level for the post code section 40 without any change at step S18. When the amplitude ratio K(RRO) is equal to or smaller than the lower threshold value or is equal to or greater than the upper threshold value (NO at step S17), the MPU 15 multiplies the amplitude ratio K(RRO) by the slice level for the servo section 30. Then, the MPU 15 determines the value obtained by multiplying the amplitude ratio K(RRO) by the slice level for the servo section 30 to be the slice level of the post code section 40, and notifies the level detection circuit 204 of the slice level thus determined at step S19. The level detection circuit 204 slices the signal reproduced from the post code section 40 at the slice level determined by the MPU 15. That is, the level detection circuit 204 corrects the amplitude of the reproduced signal that exceeds the slice level determined by the MPU 15 to the amplitude defined as the slice level.

The second embodiment is thus capable of shaping the waveform of the signal reproduced from the post code section 40 appropriately. It is thus possible to precisely read the information recorded in the servo frames 3 and to reduce the possibility that bit-base error may take place.

### Third Embodiment

A third embodiment will now be described. The third embodiment stores the amplitude ratio K(RRO) that defines the slice level for slicing the reproduced signal from the post code section 40 in a management table 300. The MPU 15 refers to the management table 300 and determines the slice level at which the reproduced signal of the post code section 40 is sliced.

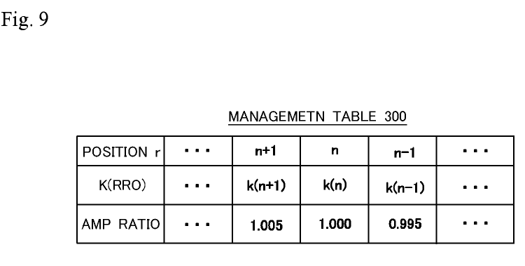

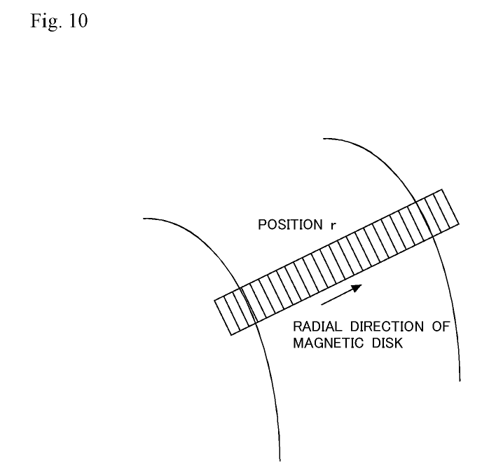

An example of the management table 300 is illustrated in FIG. 9. The management table 300 is formed in the RAM 16 by the MPU 15. As illustrated in FIG. 9, the management table 300 storages a variable r that indicates a position of the magnetic head 13 over the corresponding magnetic disk 2 in its radial direction and the amplitude ratio K(RRO) obtained at the position designated by the variable r. FIG. 10 illustrates the variable r that indicates the position of the magnetic head 13 over the magnetic disk 2 in the radial direction thereof. The variable r is incremented by 1 each time the magnetic head 13 moves outwards by a write width of one bit on the magnetic disk 2. The position of the magnetic head 13 over the magnetic disk 2 may be obtained by reading the servo information recorded in the servo section 30.

The MPU 15 receives the servo information recorded in the servo section 30 from the DSP 19, and acquires the information on the position of the magnetic head 13 over the magnetic disk 2. Then, the MPU 15 refers to the management table 300, and obtains the amplitude ratio K(RRO) at the current position of the magnetic head 13. The MPU 15 multiplies the amplitude ratio K(RRO) defined in the management table 300 by the amplitude defined as the slice level for the reproduced signal from the servo section 30 to thus obtain the slice level used at the current position. The slice level thus obtained is written in the level detection circuit 204 by the MPU 15. The level detection circuit 204 slices the signal reproduced from the post code section 40 at the slice level specified by the MPU 15. That is, the level detection circuit 204 corrects the amplitude of the reproduced signal that exceeds the slice level specified by the MPU 15 to the amplitude defined as the slice level.

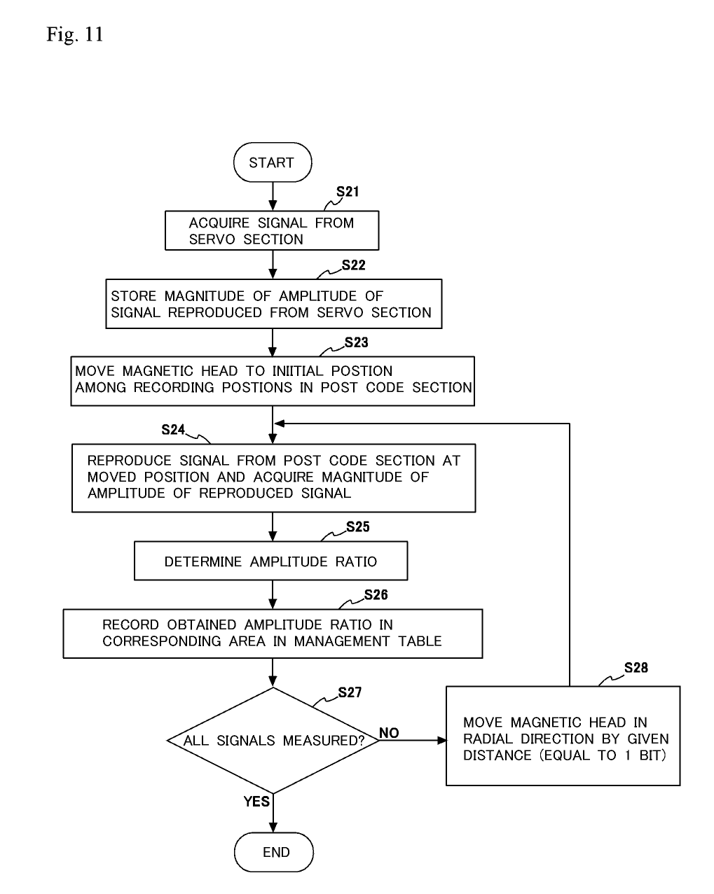

A description will now be given, with reference to a flowchart of FIG. 11, of a process of creating the management table 300 illustrated in FIG. 9. At step S21, the MPU 15 moves the magnetic head 13 to the preamble section 31 in the servo section 30, and obtains the signal produced by reproducing information recorded in the preamble section 31 by the magnetic head 13. The MPU 15 stores the magnitude of the amplitude of the signal reproduced from the servo section 30 in the RAM 16 at step S22.

The MPU 15 moves the magnetic head 13 to the initial position that is located in the innermost of the magnetic disk 2 in the radial direction at step S23. The MPU 15 reads information recorded in the post code section 40 at the initial position by using the magnetic head 13, and obtains a resultant reproduced signal. The MPU 15 stores the magnitude of the amplitude of the reproduced signal in the RAM 16 at step S24. The MPU 15 obtains the amplitude ratio K(RRO) by dividing the magnitude of the amplitude of the signal reproduced from the post code section 40 at the present position by the magnitude of the amplitude of the signal reproduced from the servo section obtained at step S21 at step S25. The MPU 15 stores the amplitude ratio K(RRO) in the management table 300 in association with the current position at step S26.

At step S27, the MPU 15 determines whether the amplitude of the reproduced signal has been measured at all of the positions in the post code section 40 where information is recorded. When the amplitude of the reproduced signal has not yet been measured at all of the positions in the post code section 40, the MPU 15 moves the magnetic head 13 outwards in the radial direction by the predetermined distance equal to the one-bit width at step S28. The MPU 15 obtains the signal reproduced from the post code section 40 at the moved position, and calculates the amplitude ratio K(RRO) at this position. The above process is repeatedly carried out until the answer of step S27 is YES. Then, the MPU 15 ends the process.

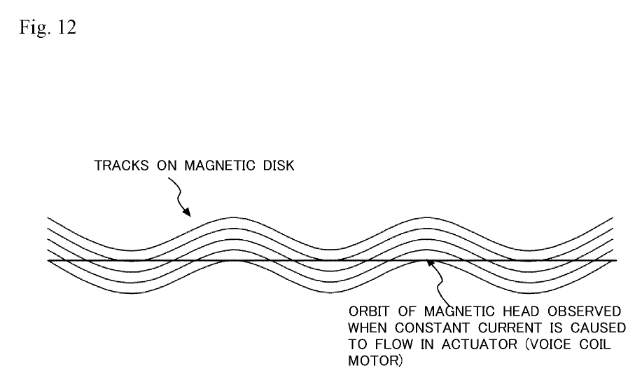

The first through third embodiments may be suitably applied to a virtual circle control that moves the magnetic head 13 so as to draw an orbit of a perfect circle about the rotational center of the magnetic disk 2 or to a variable TPI (track per inch) technique in which the recording density is varied. FIG. 12 illustrates orbits of tracks with respect to the magnetic head 13 which is kept stationary by supplying the voice coil motor (actuator) with a constant current. In the virtual circle control, the current that flows in the voice coil motor is controlled so as to follow the orbits of tracks.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A magnetic storage apparatus comprising:
a recording medium having a first area in which servo information for controlling a magnetic head is stored, and a second area in which correction information for correcting the servo information is stored;
an amplifying part configured to amplify a reproduced signal obtained by reproducing information recorded in the storage medium by the magnetic head; and
a control part configured to define a gain of the amplifying part on the basis of an amplitude of a first reference signal obtained by reproducing a first waveform for amplitude measurement stored in the first area and cause the amplifying part to amplify a first reproduced signal obtained by reproducing the servo information and being configured to define the gain of the amplifying part on the basis of an amplitude of a second reference signal obtained by reproducing a second waveform for amplitude measurement stored in the second area and cause the amplifying part to amplify a second reproduced signal obtained by reproducing the correction information.

2. The magnetic storage apparatus according to claim 1, wherein, when the amplifying part amplifies the second reproduced signal, the control part determines whether to correct the gain of the amplifying part caused to amplify the first reproduced signal on the basis of an amplitude ratio between the first reference signal and the second reference signal.

3. The magnetic storage apparatus according to claim 2, wherein the control part determines a value obtained by dividing the gain of the amplifying part for amplifying the first reproduced signal by the amplitude ratio to be the gain of the amplifying part for amplifying the second reproduced signal.

4. A magnetic storage apparatus comprising:
a recording medium having a first area in which servo information for controlling a magnetic head is stored, and a second area in which correction information for correcting the servo information is stored;
a signal correction part configured to compare an amplitude of a reproduced signal obtained by reproducing information stored in the recording medium by the magnetic head with a predetermined amplitude defined as a slice level and to correct the amplitude of the reproduced signal that exceeds the slice level to the amplitude of the slice level; and
a control part configured to define the amplitude of the slice level on the basis of a first reference signal obtained by reproducing a first waveform for amplitude measurement stored in the first area and cause the signal correction part to correct the amplitude of a first reproduced signal obtained by reproducing the servo information and being configured to define the amplitude of the slice level on the basis of an amplitude of a second reference signal obtained by reproducing a second waveform for amplitude measurement stored in the second area and cause the signal correction part to correct an amplitude of a second reproduced signal obtained by reproducing the correction information.

5. The magnetic storage apparatus according to claim 4, wherein, when the slice level of the signal correction part for correcting the amplitude of the second reproduced signal is defined, the control part determines whether to correct the slice level of the signal correction part caused to correct the amplitude of the first reproduced signal on the basis of an amplitude ratio between the first reference signal and the second reference signal.

6. The magnetic storage apparatus according to claim 5, wherein the control part determines a value obtained by multiplying the slice level for correcting the first reproduced signal by the amplitude ratio to be the slice level for correcting the second reproduced signal.

7. The magnetic storage apparatus as claimed in claim 4, further comprising a memory part that stores, at each position in the second area where information is recorded, an amplitude ratio between a signal obtained by reproducing the information stored at the each position and the first reproduced signal,
wherein, when the correction information stored in the second area is reproduced by the magnetic head, the control part is configured to obtain the amplitude ratio associated with the position at which the correction information is read by the magnetic head from the storage part and to obtain the slice level of the signal correction part at the position on the basis of the amplitude ratio and is configured to set the slice level thus obtained in the signal correction part.

8. A method for reproducing servo information comprising:
accessing a first area of a storage medium in which area servo information for controlling a magnetic head and a first waveform for amplitude correction and reproducing the servo information and the first waveform by the magnetic head;
determining a gain of an amplifying part on the basis of an amplitude of a first reference signal obtained by reproducing the first waveform by the magnetic head;
amplifying a first reproduced signal obtained by reproducing the servo information at the amplifying part;
accessing a second area of the storage medium in which correction information for correcting the servo information and a second waveform for amplitude correction and reproducing the correction information and the second waveform by the magnetic head;
determining the gain of the amplifying part on the basis of an amplitude of a second reference signal obtained by reproducing the second waveform by the magnetic head; and
amplifying a second reproduced signal obtained by reproducing the correction information at the amplifying part.

9. A method for reproducing servo information comprising:
accessing a first area of a storage medium in which area servo information for controlling a magnetic head and a first waveform for amplitude correction and reproducing the servo information and the first waveform by the magnetic head;
determining a first slice level for correcting an amplitude of a first reproduced signal obtained by reproducing the servo information on the basis of the first waveform reproduced by the magnetic head;
comparing the amplitude of the first reproduced signal with an amplitude defined as the first slice level and correcting the amplitude of the first reproduced signal that exceeds the first slice level to the amplitude of the first slice level;
accessing a second area of the storage medium in which correction information for correcting the servo information and a second waveform for amplitude correction and reproducing the correction information and the second waveform by the magnetic head;
determining a second slice level for correcting an amplitude of a second reproduced signal obtained by reproducing the correction information on the basis of an amplitude of a second reference signal obtained by reproducing the second waveform by the magnetic head; and
comparing the amplitude of the second reproduced signal with the amplitude defined as the second slice level and correcting the amplitude of the second reproduced signal that exceeds the second slice level to the amplitude of the second slice level.
